(19) United States
(12) Patent Application Publication
(10) Pub. No.: US 2024/0415330 A1
(43) Pub. Date: Dec. 19, 2024

(54) AUTOMATIC FEED MECHANISM FOR THE PELLET GRILL WITH LOUDSPEAKER

(71) Applicant: Ningbo Jiuyi Electrical Appliances Co., Ltd., Ningbo (CN)

(72) Inventor: Zaili Peng, Ningbo (CN)

(21) Appl. No.: 18/362,239

(22) Filed: Jul. 31, 2023

(30) Foreign Application Priority Data
Jun. 19, 2023 (CN) 202321567852X

(51) Int. Cl. A47J 37/07; F23B 40/02; F23N 1/00; F24B 13/04

(52) U.S. Cl. CPC A47J 37/0786; A47J 37/0704; A47J 37/0754; F23B 40/02; F23N 1/002; F24B 13/04; A47J 2202/00

(57) ABSTRACT

An automatic feed mechanism for the pellet grill with a loudspeaker comprises a feed hopper for storing pellet fuel; a loudspeaker and control panel electrically connected to the loudspeaker are provided on both sides of the inner wall of the feed hopper respectively, and the control panel incorporates a Bluetooth transceiver module for connecting Bluetooth devices and playing music; a stove stand for burning pellet fuel is provided on one side of the feed hopper, and a temperature-sensing probe is provided for detecting the internal temperature within the pellet grill; an automatic feed mechanism is provided for delivering the pellet fuel from feed hopper to stove stand, with the control panel electrically connected to the temperature-sensing probe. The invention modifies the electronic components of the control panel and adds a loudspeaker for playing music, with simple and cost-effective structures for dual purposes, realizing economic benefits and broad application prospects.

### 1. TECHNICAL FIELD

The invention relates to the field of pellet stove technology, in particular to an automatic feed mechanism for the pellet grill with a loudspeaker.

### 2. BACKGROUND ART

The pellet grill is a type of stove using biomass pellets as fuel, which is widely used in the market due to its energy-saving and environmental-friendly features.

However, the existing pellet grills have a single function with the simple heating capability by burning pellets. When conducting outdoor barbecuing, users generally play music to enhance the atmosphere and also to mask the sound of the pellet grill's combustion. However, it is necessary to carry a loudspeaker since the volume of the music from a mobile phone is low, resulting in increasing the amount of items needed to be carried, thereby significantly reducing outdoor portability and causing serious inconvenience to the user.

### 3. SUMMARY OF THE INVENTION

The invention provides an automatic feed mechanism for the pellet grill with loudspeaker to solve a problem in the background art.

To realize the above purposes, the invention provides the following technical solutions:

An automatic feed mechanism for the pellet grill with a loudspeaker comprises:
a feed hopper is provided for storing pellet fuel; a loudspeaker and a control panel electrically connected to the loudspeaker are provided on both sides of the inner wall of the feed hopper respectively; the control panel internally integrates a Bluetooth transceiver module for connecting Bluetooth devices and playing music through the loudspeaker;
a stove stand for burning pellet fuel is provided on one side of the feed hopper;
a temperature-sensing probe is provided for detecting the internal temperature of the grilling area within the pellet grill where the stove stand is located;
an automatic feed mechanism is provided for delivering the pellet fuel from inside the feed hopper to the interior of the stove stand.

Specifically, the control panel is electrically connected to the temperature-sensing probe, and the control panel is provided with a display screen for displaying the temperature parameters of the temperature-sensing probe.

Further, the control panel is provided with a temperature control knob, a volume adjustment knob, a grilling power switch, and a music power switch.

Further, one side of the feed hopper is provided with a sound output hole opposite to the baffle and a handle provided below the sound output hole.

Further, the interior of one end of the stove stand is provided with a combustion chamber, and the interior of the combustion chamber is provided with a silicon carbon rod for igniting the pellet fuel.

Further, the interior of the feed hopper is provided with a feed chamber and a sieve mesh provided inside the feed chamber, and the top of the feed hopper is provided with a hopper cover.

Further, the automatic feed mechanism comprises a feed motor provided inside the feed hopper, a feed screw provided on the output end of the feed motor, a blower motor provided inside the feed hopper and beneath the feed screw, and an air duct provided between the feed screw and the blower motor.

Further, both the air duct and one end of the feed screw extend into the interior of the stove stand and are in communication with the combustion chamber, and the other end of the feed screw is directly below the feed chamber.

Further, the side-top part of the feed chamber is provided with a feed withdrawal pull-ring that extends to the outside of the feed hopper and a feed withdrawal port provided at the bottom of the feed withdrawal pull-ring and one end inclined-extends to the outside of the feed hopper.

Compared to the prior arts, the invention provides an automatic feed mechanism for the pellet grill with loudspeaker, having the following advantages and beneficial effects:
the invention only needs to modify some electronic components of the control panel and add a loudspeaker to gain music playing functionality, with simple and compact structure, low modification cost and dual-purpose design, realizing the simple and economically beneficial operation way and promising a broad application prospect.

### 4. BRIEF DESCRIPTION OF ACCOMPANY DRAWINGS

FIG. 1 is a schematic diagram showing the structure of the invention.

FIG. 2 is a schematic diagram showing the side view of the structure of the invention.

FIG. 3 is a schematic diagram showing the sectional view of the structure of the invention.

In the figures: 1. the feed hopper; 11. the loudspeaker; 12. the control panel; 121. the temperature control knob; 122. the volume adjustment knob; 123. the grilling power switch; 124. the music power switch; 13. the sound output hole; 14. the feed chamber; 15. the sieve mesh; 16. the hopper cover; 17. the feed withdrawal pull-ring; 18. the feed withdrawal port; 19. the handle; 2. the stove stand; 21. the combustion chamber; 22. the silicon carbon rod; 3. the temperature sensing probe; 4. the automatic feed mechanism; 41. the feed motor; 42. the feed screw; 43. the blower motor; 44. the air duct.

### 5. SPECIFIC EMBODIMENT OF THE INVENTION

To make the technical solutions provided by the invention more comprehensible, a further description of the invention is given below in combination with the attached drawings and embodiments, and the embodiments are exemplary and not the limitations of the scope of the disclosure. Apparently, the described drawings are merely some embodiments of the application rather than all the embodiments of the application. It should be understood that the application is not limited to the drawings described herein. Based on the drawings in the invention, all other drawings obtained by those of ordinary skill in the art without making creative labor fall within the scope of protection of the invention.

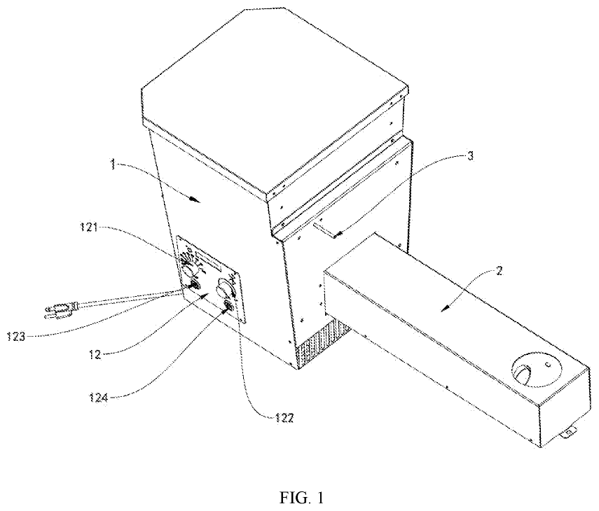

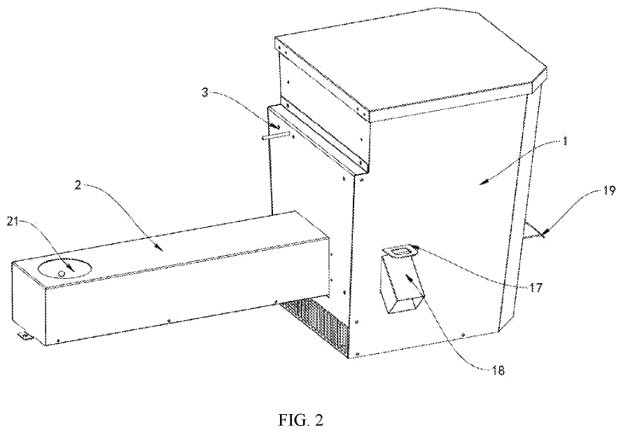

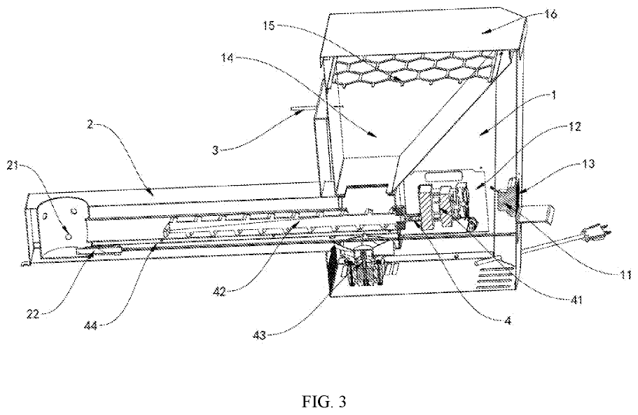

Referring to FIG. 1-3, the invention discloses an automatic feed mechanism for the pellet grill with a loudspeaker, which comprises:

The feed hopper 1 is provided for storing pellet fuel. The loudspeaker 11 and a control panel 12 electrically connected to the loudspeaker 11 are provided on both sides of the inner wall of the feed hopper 1 respectively. The control panel 12 internally integrates a Bluetooth transceiver module for connecting Bluetooth devices and playing music through the loudspeaker 11.

The stove stand 2 for burning pellet fuel. The stove stand 2 is located on one side of the feed hopper 1 and is assembled into the grill body in the later stage.

The temperature-sensing probe 3 is provided for detecting the internal temperature of the grilling area within the pellet grill where the stove stand 2 is located. The temperature-sensing probe 3 is provided on one side of the feed hopper 1, with its other end extending into the interior of the stove stand 2, to monitor the internal temperature of the grilling area within the pellet grill where the stove stand 2 is located.

The automatic feed mechanism 4 is provided for delivering the pellet fuel from inside the feed hopper 1 to the interior of the stove stand 2.

The feed hopper 1 and the stove stand 2 mainly serve to accommodate the loudspeaker 11 and the automatic feed mechanism 4. The automatic feed mechanism 4 and the loudspeaker 11 can also be applied to feed hoppers 1 and stove stands 2 of other shapes and specifications.

Specifically, the control panel 12 is electrically connected to the temperature-sensing probe 3, and the control panel 12 is provided with a display screen for displaying the temperature parameters of the temperature-sensing probe 3.

Specifically, the control panel 12 is provided with a temperature control knob 121, a volume adjustment knob 122, a grilling power switch 123, and a music power switch 124. A sound output hole 13 opposite to the plate and a handle 19 located under the sound output hole 13 are provided on one side of the feed hopper 1. One end of the stove stand 2 is internally provided with a combustion chamber 21, and a silicon carbon rod 22 is provided inside the combustion chamber 21 for igniting the pellet fuel. Referring to FIG. 1, the control panel 12 is connected to the mains electricity through a power plug. During use, the power plug is connected to the power source, the hopper cover 16 is opened, and the pellet fuel is thrown into the feed chamber 14. The grilling power switch 123 is turned on, and the display screen will show in real-time the furnace temperature sensed by the temperature-sensing probe 3. After the grilling power switch 123 is turned on and the temperature control knob 121 is not at the zero position, the silicon carbon rod 22 will automatically heat up to about 1200° C. and maintain this temperature. The temperature control knob 121 is rotated to the required set position, and the feed motor 41 will start to rotate the feed, the blower motor 43 will continuously supply air, ensuring the air needed for pellet combustion. When the burning pellets come into contact with the high-temperature silicon carbon rod 22, the burning pellets will be ignited and maintained in combustion. The heat from combustion will be blown by the wind to every corner of the stove stand 2 for baking food. At a low-temperature gear, smoke is also blown by the wind to every corner of the stove stand 2 for smoking food. During the baking process, the hopper cover 16 can be opened, and the pellet fuel can be re-thrown into the feed chamber 14 to ensure the continuity of combustion. After baking, the grilling power switch 123 can be directly turned off. During the baking process, the music power switch 124 can be turned on, and users will hear the prompt ‘Bluetooth is turned on, waiting for connection’. When the Bluetooth on user's phone is turned on, user can play music through the App on the phone. The sound of the music will be played through the loudspeaker 11, and the volume of the sound played by the loudspeaker 11 can be adjusted by the volume adjustment knob 122 or by adjusting the volume on the phone. The grilling function and the music function can be realized simultaneously without interfering with each other.

Specifically, the interior of the feed hopper 1 is provided with a feed chamber 14 and a sieve mesh 15 located inside the feed chamber 14. The top of the feed hopper 1 is equipped with a hopper cover 16. Opening the hopper cover 16 allows the introduction of pellet fuel through the sieve mesh 15 into the interior of the feed chamber 14.

Specifically, the automatic feed mechanism 4 comprises a feed motor 41 installed inside the feed hopper 1, a feed screw 42 located on the output end of the feed motor 41, a blower motor 43 set inside the feed hopper 1 and located beneath the feed screw 42, and an air duct 44 situated between the feed screw 42 and the blower motor 43. Starting the blower motor 43 allows air to enter through the air duct 44 during combustion, providing the necessary oxygen for the combustion process.

Specifically, both the air duct 44 and one end of the feed screw 42 extend into the stove stand 2 interior and are in communication with the combustion chamber 21, the other end of the feed screw 42 is provided directly beneath the feed chamber 14, and the fan is provided on the feed motor 41 for cooling purposes. The feed motor 41 is started to drive the rotation of the feed screw 42, conveying pellet fuel to the combustion chamber 21. The pellet fuel in the feed chamber 14 automatically falls into the starting end of the screw conveyor.

Specifically, the top of the feed chamber 14 is provided with a feed withdrawal pull-ring 17 that extends to the outside of the feed hopper 1 and a feed withdrawal port 18 located at the bottom of the feed withdrawal pull-ring 17, with one end inclined-extending outwards at an angle from the feed hopper 1. The feed withdrawal pull-ring 17 is pulled to allow for the discharge of any remaining pellet fuel inside the feed chamber 14 through the feed withdrawal port 18.

Compared to the prior arts, the automatic feed mechanism for the pellet grill with loudspeaker only needs to modify some electronic components of the control panel and add a loudspeaker to gain music playing functionality, with simple and compact structure, low modification cost and dual-purpose design, realizing the simple and economically beneficial operation way and promising a broad application prospect.

Although embodiments of the invention have been shown and described, it will be understood by those of ordinary skill in the art that a variety of variations, modifications, replacements and variants of these embodiments can be made without departing from the principles and spirit of the invention. Therefore, the protection scope of the invention should be subject to the protection scope defined by the claims and equivalents thereof.

1. An automatic feed mechanism for the pellet grill with a loudspeaker, wherein comprises:
a feed hopper (1) is provided for storing pellet fuel; a loudspeaker (11) and a control panel (12) electrically connected to the loudspeaker (11) are provided on both sides of the inner wall of the feed hopper (1) respectively; the control panel (12) internally integrates a Bluetooth transceiver module for connecting Bluetooth devices and playing music through the loudspeaker (11);
a stove stand (2) for burning pellet fuel is provided on one side of the feed hopper (1);
a temperature-sensing probe (3) is provided for detecting the internal temperature of the grilling area within the pellet grill where the stove stand (2) is located;
an automatic feed mechanism (4) is provided for delivering the pellet fuel from inside the feed hopper (1) to the interior of the stove stand (2).

2. An automatic feed mechanism for the pellet grill with a loudspeaker of claim 1, wherein the control panel (12) is electrically connected to the temperature-sensing probe (3), and the control panel (12) is provided with a display screen for displaying the temperature parameters of the temperature-sensing probe (3).

3. An automatic feed mechanism for the pellet grill with a loudspeaker of claim 1, wherein the control panel (12) is provided with a temperature control knob (121), a volume adjustment knob (122), a grilling power switch (123), and a music power switch (124).

4. An automatic feed mechanism for the pellet grill with a loudspeaker of claim 1, wherein one side of the feed hopper (1) is provided with a sound output hole (13) opposite to the baffle and a handle (19) provided below the sound output hole (13).

5. An automatic feed mechanism for the pellet grill with a loudspeaker of claim 1, wherein the interior of one end of the stove stand (2) is provided with a combustion chamber (21), and the interior of the combustion chamber (21) is provided with a silicon carbon rod (22) for igniting the pellet fuel.

6. An automatic feed mechanism for the pellet grill with a loudspeaker of claim 1, wherein the interior of the feed hopper (1) is provided with a feed chamber (14) and a sieve mesh (15) provided inside the feed chamber (14), and the top of the feed hopper (1) is provided with a hopper cover (16).

7. An automatic feed mechanism for the pellet grill with a loudspeaker of claim 6, wherein the automatic feed mechanism (4) comprises a feed motor (41) provided inside the feed hopper (1), a feed screw (42) provided on the output end of the feed motor (41), a blower motor (43) provided inside the feed hopper (1) and beneath the feed screw (42), and an air duct (44) provided between the feed screw (42) and the blower motor (43).

8. An automatic feed mechanism for the pellet grill with a loudspeaker of claim 7, wherein both the air duct (44) and one end of the feed screw (42) extend into the interior of the stove stand (2) and are in communication with the combustion chamber (21), and the other end of the feed screw (42) is directly below the feed chamber (14).

9. An automatic feed mechanism for the pellet grill with a loudspeaker of claim 8, wherein the side-top part of the feed chamber (14) is provided with a feed withdrawal pull-ring (17) that extends to the outside of the feed hopper (1) and a feed withdrawal port (18) provided at the bottom of the feed withdrawal pull-ring (17) and one end inclined-extends at an angle to the outside of the feed hopper (1).
